(19) United States
(12) Patent Application Publication
(10) Pub. No.: US 2019/0074916 A1
(43) Pub. Date: Mar. 7, 2019

(54) METHOD AND DEVICE FOR DETECTING SIGNAL STRENGTH

(71) Applicant: CHINA MOBILE COMMUNICATIONS GROUP CO., LTD., Beijing (CN)

(72) Inventors: Xiaoran ZHANG, Beijing (CN); Nan HU, Beijing (CN); Qun PAN, Beijing (CN); Nan LI, Beijing (CN)

(21) Appl. No.: 15/762,519

(22) PCT Filed: Sep. 2, 2016
(86) PCT No.: PCT/CN2016/097849

§ 371 Date: Mar. 22, 2018

(30) Foreign Application Priority Data
Sep. 22, 2015 (CN) 201510607929.5

(51) Int. Cl. H04B 17/318; H04W 24/10; H04W 24/08; H04W 48/16; H04L 5/00

(52) U.S. Cl. CPC H04B 17/318; H04W 24/10; H04L 5/0048; H04W 48/16; H04W 24/08

(57) ABSTRACT

Provided are a method and device for detecting signal strength. The method comprises: receiving measurement configuration information and report configuration information about received signal strength indication (RSSI) measurement issued by a network side; conducting RSSI measurement according to the measurement configuration information to obtain an RSSI sample value; and according to the report configuration information, processing the RSSI sample value to obtain a report value of the RSSI measurement, and reporting the report value of the RSSI measurement to the network side.

### CROSS-REFERENCE TO RELATED APPLICATIONS

The present application claims priority to Chinese Patent Application No. 201510607929.5, filed on Sep. 22, 2015, the contents of which are hereby incorporated by reference in its entirety.

### TECHNICAL FIELD

The disclosure relates to the field of mobile communications, and particularly to a method for signal strength detection and device.

### BACKGROUND

At present, in a Long Term Evolution (LTE) network, a measurement and reporting result of a terminal includes Reference Signal Received Power (RSRP) and Reference Signal Received Quality (RSRQ), wherein the RSRP is a mean value of signal strength of Cell-specific Reference Signal (CRS) locations of a serving cell, and reflects signal strength; and RSRQ=N×RSRP/RSSI, wherein the RSRQ reflects signal quality, a Received Signal Strength Indication (RSSI) represents total power of a useful signal, interference and noise, and N represents a number of Resource Blocks (RBs) in a measurement bandwidth. The terminal may measure and report the RSRP and the RSRQ for mobility management, wherein mobility management includes cell selection, reselection, handover, cell activation and deactivation during carrier aggregation and the like.

However, for an LTE system operating on an unlicensed frequency band, since Wireless Fidelity (WIFI) or another operator may share the frequency band, it is necessary to consider factors such as signal quality of a carrier on the unlicensed frequency band, a busy/idle condition of a channel and the like. For such a condition, a base station may perform Listen Before Talk (LBT) before downlink sending to judge whether the channel is available. In addition, RSRP and RSRQ measured and reported by a terminal may also assist a network in learning about signal quality and interference condition of a terminal side. However, since base stations of multiple operators may work on a carrier of the same unlicensed frequency band, there may exist the condition of “hidden node”, which may cause the condition of no interference on a base station side but serious interference on the terminal side, although the base stations may perform LBT before downlink sending. For example, as shown in FIG. 1, a base station of an operator A monitors that a channel is idle, and sends data to a terminal. But from a terminal side, a base station of an operator B brings relatively strong interference and works on a carrier of the same unlicensed frequency band. Therefore, the conditions of demodulation errors, incapability of correctly receiving the data and the like may occur to the terminal under the condition of relatively strong interference.

For the problems, although a network may learn about signal quality and interference condition of a terminal side through RSRP and RSRQ information reported by a terminal, RSRP is signal strength of CRS locations of a serving cell, RSRQ is a ratio of the signal strength of CRSs and total power, and the two measures may not directly reflect an interference condition of different operators and different systems.

Therefore, it is necessary to provide a measurement and reporting solution capable of directly reflecting an interference condition of different operators or different systems.

### SUMMARY

In order to solve the problem that a measurement and reporting solution in the related art cannot directly reflect an interference condition among different operators or different systems, the disclosure provides a and device for signal strength detection.

In order to solve the technical problem, the disclosure provides a method for signal strength detection, which may include that:

measurement configuration information and reporting configuration information for RSSI measurement are sent to a terminal; and

a report value of RSSI measurement reported by the terminal is received, wherein the measurement configuration information may be configured to indicate the terminal to perform RSSI measurement to obtain RSSI sample values, and the reporting configuration information may be configured to indicate the terminal to process the RSSI sample values to obtain the report value of RSSI measurement.

Alternatively, the measurement configuration information may include at least one of measurement frequency, measurement configuration of a reference signal, an RSSI measurement starting event or period, or prompt information, wherein the prompt information may be used to prompt whether to remove a RSRP of a serving cell from the RSSI sample values.

Alternatively, the reporting configuration information may include: an RSSI reporting threshold value and an RSSI reporting event or period.

Alternatively, the reporting configuration information may further include a reporting type of the RSSI sample values, wherein the reporting type of the RSSI sample values may be at least one of a mean value of the RSSI sample values, a ratio of the RSSI sample values higher than the RSSI reporting threshold value to all the RSSI sample values, or a mean value of the RSSI sample values higher than the RSSI reporting threshold value.

According to another aspect of the disclosure, a method for signal strength detection is further provided, which may include that:

measurement configuration information and reporting configuration information for RSSI measurement issued from a network side are received;

RSSI measurement is performed to obtain RSSI sample values according to the measurement configuration information; and

the RSSI sample values are processed to obtain a report value of RSSI measurement according to the reporting configuration information, and the report value of RSSI measurement is reported to the network side.

Alternatively, the measurement configuration information may include at least one of measurement frequency, measurement configuration of a reference signal, an RSSI measurement starting event or period, or prompt information, wherein the prompt information may be configured to prompt whether to remove RSRP of a serving cell from the RSSI sample values.

Alternatively, the operation that RSSI measurement is performed to obtain the RSSI sample values according to the measurement configuration information may specifically include that: when the RSSI measurement starting event or period is met, RSSI measurement is performed to obtain the RSSI sample values; when the RSSI sample values include valid reference signals, a RSRP in the RSSI sample values is removed, and the processed RSSI sample values are regarded as first RSSI sample values; and when the RSSI sample values do not include any valid reference signal, the RSSI sample values are regarded as second RSSI sample values.

Alternatively, the operation that the RSRP in the RSSI sample values is removed and the processed RSSI sample values are regarded as the first RSSI sample values may include: the RSRP in the RSSI sample values is subtracted according to RSSI_DRS=RSSI_drs-RSRP, wherein RSSI_DRS may represent the first RSSI sample value, RSSI_drs may represent the RSSI sample value, and RSRP may represent RSRP of a serving cell; or, the RSRP in the RSSI sample values is subtracted according to RSSI_DRS=RSSI_drs-N×RSRP, wherein RSSI_DRS may represent the first RSSI sample value, RSSI_drs may represent the RSSI sample value, N may represent a number of RBs in a measurement bandwidth, and RSRP may represent the RSRP of the serving cell; or, the RSRP in the RSSI sample values is subtracted according to RSSI_DRS=RSSI_drs-N×M×RSRP, wherein RSSI_DRS may represent the first RSSI sample value, RSSI_drs may represent the RSSI sample value, N may represent the number of RBs in the measurement bandwidth, M may represent a number of Resource Elements (REs) configured for RSRP measurement in each RB, and RSRP may represent the RSRP of the serving cell.

Alternatively, the operation that the RSSI sample values are processed to obtain the report value of RSSI measurement according to the reporting configuration information and the report value of RSSI measurement is reported to the network side may specifically include that: the first RSSI sample values and the second RSSI sample values are combined into an RSSI sample set; the first RSSI sample values and second RSSI sample values in the RSSI sample value set are processed to obtain the report value of RSSI measurement according to a reporting type of the RSSI sample values, wherein the reporting configuration information may include the reporting type of the RSSI sample values; and the report value of RSSI measurement is reported to the network side.

Alternatively, the reporting type of the RSSI sample values may be at least one of a mean value of the RSSI sample values, a ratio of the RSSI sample values higher than an RSSI reporting threshold value to all the RSSI sample values, or a mean value of the RSSI sample values higher than the RSSI reporting threshold value.

Alternatively, the reporting configuration information may include the RSSI reporting threshold value and an RSSI reporting event or period.

According to another aspect of the disclosure, a device for signal strength detection is further provided, which may include:

a sending module, configured to send measurement configuration information and reporting configuration information for RSSI measurement to a terminal; and

a first receiving module, configured to receive a report value of RSSI measurement reported by the terminal, wherein the measurement configuration information is used to instruct the terminal to perform the RSSI measurement to obtain RSSI sample values, and the reporting configuration information is used to instruct the terminal to process the RSSI sample values to obtain the report value of the RSSI measurement.

Alternatively, the measurement configuration information may include at least one of measurement frequency, a measurement configuration of a reference signal, an RSSI measurement starting event or period and prompt information, wherein the prompt information may be used to prompt whether to remove a RSRP of a serving cell from the RSSI sample values.

Alternatively, the reporting configuration information may include: an RSSI reporting threshold value and an RSSI reporting event or period.

Alternatively, the reporting configuration information may further include a reporting type of the RSSI sample values, wherein the reporting type of the RSSI sample values may be at least one of a mean value of the RSSI sample values, a ratio of the RSSI sample values higher than the RSSI reporting threshold value to all the RSSI sample values, or a mean value of the RSSI sample values higher than the RSSI reporting threshold value.

According to another aspect of the disclosure, a device for signal strength detection is further provided, which may include:

a second receiving module, configured to receive measurement configuration information and reporting configuration information for RSSI measurement issued from a network side;

a first processing module, configured to perform the RSSI measurement to obtain RSSI sample values according to the measurement configuration information; and

a second processing module, configured to process the RSSI sample values to obtain a report value of RSSI measurement according to the reporting configuration information, and report the report value of RSSI measurement to the network side. Alternatively, the measurement configuration information may include at least one of measurement frequency, a measurement configuration of a reference signal, an RSSI measurement starting event or period and prompt information, wherein the prompt information may be configured to prompt whether to remove a RSRP of a serving cell from the RSSI sample values.

Alternatively, the first processing module may further be configured to, when the RSSI measurement starting event or period is met, perform RSSI measurement to obtain the RSSI sample values; when the RSSI sample values include a valid reference signal, remove RSRP in the RSSI sample values, and statistically determine the processed RSSI sample values as first RSSI sample values; and when the RSSI sample values do not include any valid reference signal, statistically determine the RSSI sample values as second RSSI sample values.

Alternatively, the first processing module may further be configured to subtract the RSRP in the RSSI sample values according to RSSI_DRS=RSSI drs-RSRP, wherein RSSI_DRS may represent the first RSSI sample value, RSSI_drs may represent the RSSI sample value, and RSRP may represent the RSRP of the serving cell; or, subtract the RSRP in the RSSI sample values according to RSSI_DRS=RSSI_drs-N×RSRP, wherein RSSI_DRS may represent the first RSSI sample value, RSSI_drs may represent the RSSI sample value, N may represent a number of RBs in a measurement bandwidth, and RSRP may represent the RSRP of the serving cell; or, subtract the RSRP in the RSSI sample values according to RSSI_DRS=RSSI_drs-N×M×RSRP, wherein RSSI_DRS may represent the first RSSI sample value, RSSI_drs may represent the RSSI sample value, N may represent the number of RBs in the measurement bandwidth, M may represent a number of REs configured for RSRP measurement in each RB, and RSRP may represent the RSRP of the serving cell.

Alternatively, the second processing module may further be configured to combine the first RSSI sample values and the second RSSI sample values into an RSSI sample set; process the first RSSI sample values and second RSSI sample values in the RSSI sample value set to obtain the report value of RSSI measurement according to a reporting type of the RSSI sample values, wherein the reporting configuration information may include the reporting type of the RSSI sample values; and report the report value of RSSI measurement to the network side.

Alternatively, the reporting type of the RSSI sample values may be at least one of a mean value of the RSSI sample values, a ratio of the RSSI sample values higher than an RSSI reporting threshold value to all the RSSI sample values, or a mean value of the RSSI sample values higher than the RSSI reporting threshold value.

Alternatively, the reporting configuration information may include the RSSI reporting threshold value and an RSSI reporting event or period.

The disclosure has the following beneficial effects.

In the disclosure, the terminal may perform RSSI measurement and reporting according to the received measurement configuration information and reporting configuration information for RSSI measurement, and after receiving the report value of RSSI measurement reported by the terminal, the network side may discover a hidden node according to the received report value of RSSI measurement, that is, the hidden node may be found through RSSI measurement of the terminal in the disclosure. In addition, the RSSI-based measurement control flow of the disclosure may ensure that the report value of RSSI measurement reported by the terminal may reflect an interference condition as accurately as possible, and an interference condition among different operators or different systems may further be directly reflected.

### BRIEF DESCRIPTION OF DRAWINGS

In order to describe the technical solutions of the embodiments of the application more clearly, the drawings required to be used for descriptions about the embodiments will be simply introduced. Obviously, the drawings described below are only some embodiments recorded in the application. Those skilled in the art may further obtain other drawings according to these drawings without creative work. The following drawings are not equally scaled intentionally according to actual sizes, and the point is to show the main purpose of the application.

FIG. 1 is a schematic diagram illustrating that when an operator A sends data to a terminal, the terminal is subjected to interference of an operator B operating on a carrier of the same unlicensed frequency band.

FIG. 2 is a flowchart of a method for signal strength detection applied to a network side according to an embodiment of the disclosure.

FIG. 3 is a main flowchart of a method for signal strength detection applied to a terminal according to an embodiment of the disclosure.

FIG. 4 is a detailed flowchart of a method for signal strength detection applied to a terminal according to an embodiment of the disclosure.

FIG. 5 is a structure block diagram of a device for signal strength detection applied to a network side according to an embodiment of the disclosure.

FIG. 6 is a structure block diagram of a device for signal strength detection applied to a terminal according to an embodiment of the disclosure.

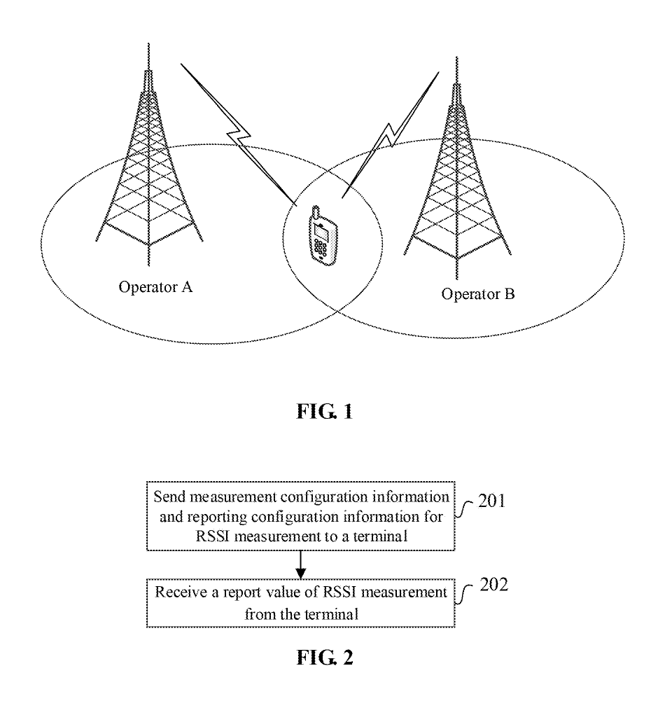

### DETAILED DESCRIPTION

The technical solutions in some embodiments of the disclosure will be clearly and completely described below in combination with the drawings in some embodiments of the disclosure. Obviously, the described embodiments are not all embodiments but only some embodiments of the disclosure. All other embodiments obtained by those skilled in the art on the basis of the embodiments in the disclosure without creative work shall fall within the scope of protection of the disclosure.

FIG. 2 is a flowchart of a method for signal strength detection applied to a network side according to an embodiment of the disclosure. The method may be performed by a base station. The method includes the following steps.

In Step 201, measurement configuration information and reporting configuration information for RSSI measurement are sent to a terminal.

In the step, the measurement configuration information for RSSI measurement may include at least one of measurement frequency, measurement configuration of a reference signal, an RSSI measurement starting event or period and prompt information. The prompt information is used to prompt whether to remove a RSRP of a serving cell from RSSI sample values. The reporting configuration information for RSSI measurement may include: an RSSI reporting threshold value and an RSSI reporting event or period.

Specifically, the measurement configuration of the reference signal includes at least one of a measurement period, a measurement opportunity in the period, or a duration of one measurement opportunity. In addition, when the measurement frequency includes multiple measurement cells, a network side may further send measurement configuration information including a measurement cell list at the measurement frequency to the terminal. At this moment, the prompt information for prompting whether to remove the RSRP of the serving cell from the RSSI sample values may be prompt information for the measurement frequency, or may be prompt information for each measurement cell in the measurement cell list.

Specifically, the reporting configuration information may further include a reporting type of the RSSI sample values. The reporting type of the RSSI sample values may be at least one of a mean value of the RSSI sample values, a ratio of the RSSI sample values higher than the RSSI reporting threshold value to all the RSSI sample values, or a mean value of the RSSI sample values higher than the RSSI reporting threshold value.

In addition, if the reporting configuration information further includes an RSSI measurement time or an RSSI measurement sample number, the mean value of the RSSI sample values may be a mean value within the RSSI measurement time or of the number of the RSSI measurement sample values; the ratio of the RSSI sample values higher than the RSSI reporting threshold value to all the RSSI sample values may be a ratio of the RSSI sample values higher than the RSSI reporting threshold value to all the RSSI sample values within the RSSI measurement time or of the number of the RSSI measurement sample values; and the mean value of the RSSI sample values higher than the RSSI reporting threshold value may be a mean value of the RSSI sample values higher than the RSSI reporting threshold value within the RSSI measurement time or within the number of the RSSI measurement samples.

In Step 202, a report value of RSSI measurement reported by the terminal is received.

In the step, specifically, the report value of RSSI measurement is obtained by processing the RSSI sample values by the terminal according to the reporting configuration information in Step 101, where the RSSI sample values are obtained by performing RSSI measurement by the terminal according to the measurement configuration information in Step 101.

In the embodiment, the network side sends the measurement configuration information for RSSI measurement and the reporting configuration information for RSSI measurement to the terminal at first to enable the terminal to perform RSSI measurement and reporting according to the received measurement configuration information and reporting information for RSSI measurement, and then receives the report value of RSSI measurement reported by the terminal, so that the problem that an existing terminal does not support reporting of a report value of RSSI measurement is solved.

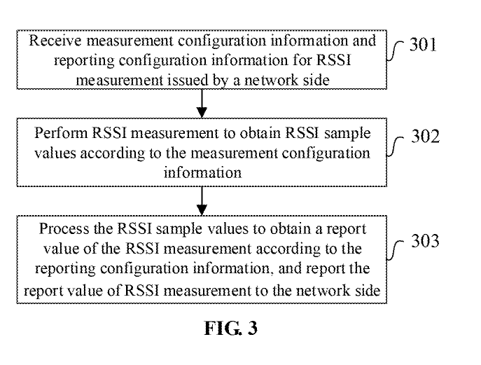

FIG. 3 is a main flowchart of a method for signal strength detection applied to a terminal according to an embodiment of the disclosure. The method may be performed by a terminal. The method includes the following steps.

In Step 301, measurement configuration information and reporting configuration information for RSSI measurement issued from a network side are received.

In the step, the terminal receives the measurement configuration information and reporting configuration information for RSSI measurement issued from the network side.

In Step 302, RSSI measurement is performed to obtain RSSI sample values according to the measurement configuration information.

In the step, the terminal may perform RSSI measurement to obtain the RSSI sample values according to the received measurement configuration information for RSSI measurement issued from the network side.

In Step 303, the RSSI sample values are processed to obtain a report value of RSSI measurement according to the reporting configuration information, and the report value of RSSI measurement is reported to the network side.

In the step, the terminal may process the RSSI sample values according to the received reporting configuration information for RSSI measurement issued from the network side, and then reports the processed report value of RSSI measurement to the network side.

In the embodiment, after receiving the measurement configuration information and reporting configuration information for RSSI measurement, the terminal may perform RSSI measurement to obtain the RSSI sample values according to the measurement configuration information, then process the RSSI sample values according to the reporting configuration information and report the processed report value of RSSI measurement to the network side; and after receiving the report value of RSSI measurement, the network side may discover a hidden node according to the received report value of RSSI measurement, that is, the hidden node may be found through RSSI measurement of the terminal in the disclosure. In addition, in the disclosure, the RSSI-based measurement control flow of the disclosure may ensure that the report value of RSSI measurement reported by the terminal may reflect an interference condition as accurately as possible, and an interference condition among different operators or different systems may further be directly reflected.

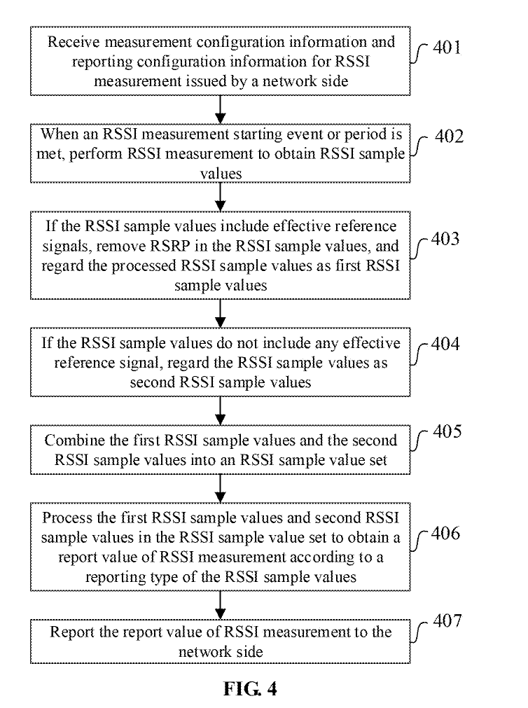

FIG. 4 is a detailed flowchart of a method for signal strength detection applied to a terminal according to an embodiment of the disclosure. The method includes the following steps.

In Step 401, measurement configuration information and reporting configuration information for RSSI measurement issued from a network side are received.

In the step, specifically, the measurement configuration information for RSSI measurement may include at least one of measurement frequency, measurement configuration of a reference signal, an RSSI measurement starting event or period, or prompt information. The prompt information is used to prompt whether to remove RSRP of a serving cell from RSSI sample values. The reporting configuration information for RSSI measurement may include: an RSSI reporting threshold value and an RSSI reporting event or period.

Specifically, the reporting configuration information may further include a reporting type of the RSSI sample values. The reporting type of the RSSI sample values may be at least one of a mean value of the RSSI sample values, a ratio of the RSSI sample values higher than the RSSI reporting threshold value to all the RSSI sample values, or a mean value of the RSSI sample values higher than the RSSI reporting threshold value.

In addition, if the reporting configuration information further includes an RSSI measurement time or an RSSI measurement sample number, the mean value of the RSSI sample values may be a mean value within the RSSI measurement time or within the number of the RSSI measurement samples; the ratio of the RSSI sample values higher than the RSSI reporting threshold value to all the RSSI sample values may be a ratio of the RSSI sample values higher than the RSSI reporting threshold value to all the RSSI sample values within the RSSI measurement time or within the number of the RSSI measurement samples; and the mean value of the RSSI sample values higher than the RSSI reporting threshold value may be a mean value of the RSSI sample values higher than the RSSI reporting threshold value within the RSSI measurement time or within the number of the RSSI measurement samples.

In Step 402, when the RSSI measurement starting event or period is met, RSSI measurement is performed to obtain the RSSI sample values.

In the step, when the terminal meets the RSSI measurement starting event or period, the terminal starts performing RSSI measurement and obtains the RSSI sample values. Specifically, the RSSI measurement starting event or period may be included in the measurement configuration information for RSSI measurement, and is transmitted to the terminal by the network side.

In Step 403, if the RSSI sample values include a valid reference signal, an RSRP in the RSSI sample values is removed, and the processed RSSI sample values are regarded as first RSSI sample values.

Specifically, present RSSI for RSRQ calculation includes interference and noise, and further includes a useful signal. In order to eliminate influence of the useful signal as much as possible, an RSRP signal of a specified serving cell may be removed from the RSSI. In addition, a use of the RSSI is different from uses of RSRP and RSRQ, the RSRP and the RSRQ are used for mobility management, while the RSSI is used to discover a hidden node and the like. A scenario where a hidden node exists may be that: a base station discovers that a channel is idle after LBT, while a report value of RSSI measurement reported by the terminal is very high (which indicates that the channel is busy), in this case, there may be a “hidden node”.

In the step, the terminal has to determine whether the RSSI sample values obtained by each measurement include a valid reference signal. If the RSSI sample values include a valid reference signal, the RSRP in the RSSI sample value is removed, and the processed RSSI sample values are regarded as first RSSI sample values.

Specifically, the RSRP in the RSSI sample values may be subtracted according to RSSI_DRS=RSSI_drs-RSRP, where RSSI_DRS represents the first RSSI sample value, RSSI_drs represents the RSSI sample value, and RSRP represents the RSRP of the serving cell; or,

the RSRP in the RSSI sample values is subtracted according to RSSI_DRS=RSSI_drs-N×RSRP, where RSSI_DRS represents the first RSSI sample value, RSSI_drs represents the RSSI sample value, N represents a number of RBs in a measurement bandwidth, and RSRP represents the RSRP of the serving cell; or,

the RSRP in the RSSI sample values is subtracted according to RSSI_DRS=RSSI_drs-N×M×RSRP, where RSSI_DRS represents the first RSSI sample value, RSSI_drs represents the RSSI sample value, N represents the number of RBs in the measurement bandwidth, M represents a number of REs for RSRP measurement in each RB, and RSRP represents the RSRP of the serving cell.

It is to be noted here that the measurement bandwidth in the step does not refer to an operating bandwidth of the network side, and may refer to a local time-frequency location, for example, only a location corresponding to an uplink scheduling grant. In addition, the reference signal may be a Discovery Reference Signal (DRS), but is not limited to such a reference signal.

In Step 404, if the RSSI sample values do not include any valid reference signal, the RSSI sample values are regarded as second RSSI sample values.

In the step, if the RSSI sample values do not include any valid reference signals, the RSRP is not required to be subtracted from the RSSI sample values, and the RSSI sample values are directly regarded as the second RSSI sample values. Specifically, the reference signals may be DRSs, and are not limited to such reference signals.

Alternatively, the terminal may further perform RSSI measurement through conventional CRS, and if RSSI measurement is performed through the conventional CRS, the RSSI sample values are regarded as third RSSI sample values. For the third RSSI sample values, the network side and the terminal may preset whether RSRP is to be subtracted, and when the RSSI sample values are obtained, the RSRP is reserved or removed according to whether the RSRP is to be removed.

In Step 405, the first RSSI sample values and the second RSSI sample values are combined into an RSSI sample value set.

In the step, the first RSSI sample values and the second RSSI sample values are not distinguished, and instead, the first RSSI sample values and the second RSSI sample values are combined into an RSSI sample value set.

In Step 406, the first RSSI sample values and second RSSI sample values in the RSSI sample value set are processed to obtain a report value of RSSI measurement according to the reporting type of the RSSI sample values.

In the step, the reporting type of the RSSI sample values is included in the reporting configuration information, and the terminal may process all the RSSI sample values in the RSSI sample value set according to the reporting type of the RSSI sample values, that is, the first RSSI sample values and second RSSI sample values in the RSSI sample value set are processed together. Alternatively, when the RSSI sample values include the third RSSI sample values, the terminal may add the third RSSI sample values into the RSSI sample value set at the same time.

Specifically, the reporting type of the RSSI sample values may be at least one of a mean value of the RSSI sample values, a ratio of the RSSI sample values higher than the RSSI reporting threshold value to all the RSSI sample values, or a mean value of the RSSI sample values higher than the RSSI reporting threshold value.

In addition, if the reporting configuration information further includes the RSSI measurement time or the RSSI measurement sample number, the mean value of the RSSI sample values may be the mean value within the RSSI measurement time or within the number of the RSSI measurement samples; the ratio of the RSSI sample values higher than the RSSI reporting threshold value to all the RSSI sample values may be the ratio of the RSSI sample values higher than the RSSI reporting threshold value to all the RSSI sample values within the RSSI measurement time or within the number of the RSSI measurement samples; and the mean value of the RSSI sample values higher than the RSSI reporting threshold value may be the mean value of the RSSI sample values higher than the RSSI reporting threshold value within the RSSI measurement time or within the number of the RSSI measurement samples.

In Step 407, the report value of RSSI measurement is reported to the network side.

In the step, specifically, when the measurement frequency included in the measurement configuration information for RSSI measurement includes multiple measurement cells, when the report value of RSSI measurement is reported, reporting may be performed corresponding to the measurement frequency or the certain cell. Specifically, the terminal may periodically report or nonperiodically report a report value of RSSI measurement corresponding to the measurement frequency; or, the terminal may periodically or nonperiodically report a report value of the RSSI measurement corresponding to each cell in the measurement cell list.

Alternatively, when performing periodic reporting, the terminal may further report a measurement sample number for calculating the report value of RSSI measurement by the terminal within the period. When performing the nonperiodic reporting, the terminal may further report the measurement sample number or measurement time for calculating the report value of RSSI measurement by the terminal within the period.

In the embodiment, the measurement configuration information, received by the terminal, for RSSI measurement includes the prompt information configured to prompt whether to remove the RSRP of the serving cell from the RSSI sample values, and the reporting configuration information for RSSI measurement includes reporting types of multiple RSSI sample values. When the terminal performs RSSI measurement, the terminal may determine whether to remove the RSRP in the RSSI sample values according to whether the RSSI sample values include a valid reference signal, make statistics on the RSSI sample values separately according to whether to remove the RSRP, and report the report value of RSSI measurement during subsequent RSSI measurement reporting. According to the embodiment, whether to remove the RSRP in the RSSI sample values is determined according to whether the RSSI sample values include a valid reference signal, that is, a corresponding RSSI measurement algorithm, reporting mechanism and flow are defined, so that it is ensured that the report value of RSSI measurement reported by the terminal may reflect an interference condition as accurately as possible, an interference condition among different operators or different systems is further directly reflected, and the problems of hidden node and the like are discovered.

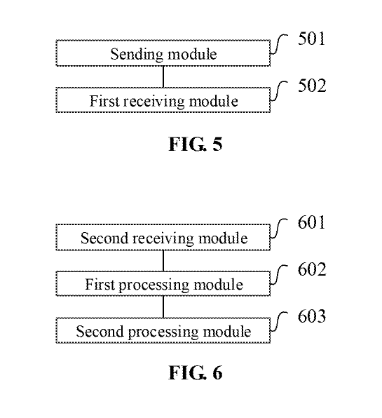

FIG. 5 is a structure block diagram of a device for signal strength detection applied to a network side according to an embodiment of the disclosure. The device includes:

a sending module 501, configured to send measurement configuration information and reporting configuration information for RSSI measurement to a terminal; and

a first receiving module 502, configured to receive a report value of RSSI measurement reported by the terminal, wherein the measurement configuration information is used to instruct the terminal to perform the RSSI measurement to obtain RSSI sample values, and the reporting configuration information is used to instruct the terminal to process the RSSI sample values to obtain the report value of the RSSI measurement.

Alternatively, the measurement configuration information includes at least one of measurement frequency, a measurement configuration of a reference signal, an RSSI measurement starting event or period and prompt information, wherein the prompt information is used to prompt whether to remove RSRP of a serving cell from the RSSI sample values.

Alternatively, the reporting configuration information includes: an RSSI reporting threshold value and an RSSI reporting event or period.

Alternatively, the reporting configuration information further includes a reporting type of the RSSI sample values, wherein the reporting type of the RSSI sample values is at least one of a mean value of the RSSI sample values, a ratio of the RSSI sample values higher than the RSSI reporting threshold value to all the RSSI sample values, or a mean value of the RSSI sample values higher than the RSSI reporting threshold value.

FIG. 6 is a structure block diagram of a device for signal strength detection applied to a terminal side according to an embodiment of the disclosure. The device includes a second receiving module 601, a first processing module 602, and a second processing module 603.

The second receiving module 601 is configured to receive measurement configuration information and reporting configuration information, transmitted by a network side, for RSSI measurement.

The first processing module 602 is configured to perform RSSI measurement to obtain RSSI sample values according to the measurement configuration information.

The second processing module 603 is configured to process the RSSI sample values to obtain a report value of RSSI measurement according to the reporting configuration information, and report the report value of RSSI measurement to the network side.

Alternatively, the measurement configuration information includes at least one of measurement frequency, measurement configuration of a reference signal, an RSSI measurement starting event or period and prompt information, where the prompt information is used to prompt whether to remove RSRP of a serving cell from the RSSI sample values.

Alternatively, the first processing module 602 is further configured to, when the RSSI measurement starting event or period is met, perform RSSI measurement to obtain the RSSI sample values; when the RSSI sample values include a valid reference signal, remove a RSRP in the RSSI sample values, and regard the processed RSSI sample values as first RSSI sample values; and when the RSSI sample values do not include any valid reference signal, regard the RSSI sample values as second RSSI sample values.

Alternatively, the first processing module 602 is further configured to subtract the RSRP in the RSSI sample values according to RSSI_DRS=RSSI_drs-RSRP, wherein RSSI_DRS represents the first RSSI sample value, RSSI_drs represents the RSSI sample value, and RSRP represents RSRP of a serving cell; or, subtract the RSRP in the RSSI sample values according to RSSI_DRS=RSSI_drs-N×RSRP, wherein RSSI_DRS represents the first RSSI sample value, RSSI_drs represents the RSSI sample value, N represents a number of RBs in a measurement bandwidth, and RSRP represents the RSRP of the serving cell; or, subtract the RSRP in the RSSI sample values according to RSSI_DRS=RSSI_drs-N×M×RSRP, wherein RSSI_DRS represents the first RSSI sample value, RSSI_drs represents the RSSI sample value, N represents the number of RBs in the measurement bandwidth, M represents a number of REs configured for RSRP measurement in each RB, and RSRP represents the RSRP of the serving cell.

Alternatively, the second processing module 603 is further configured to combine the first RSSI sample values and the second RSSI sample values into an RSSI sample set; process the first RSSI sample values and second RSSI sample values in the RSSI sample value set to obtain the report value of RSSI measurement according to a reporting type of the RSSI sample values, the reporting configuration information includes the reporting type of the RSSI sample values; and report the report value of RSSI measurement to the network side.

Alternatively, the reporting type of the RSSI sample values is at least one of a mean value of the RSSI sample values, a ratio of the RSSI sample values higher than an RSSI reporting threshold value to all the RSSI sample values, or a mean value of the RSSI sample values higher than the RSSI reporting threshold value.

Alternatively, the reporting configuration information includes the RSSI reporting threshold value and an RSSI reporting event or period.

The above is the preferred implementation mode of the disclosure. It should be pointed out that those skilled in the art may further make a plurality of improvements and embellishments without departing from the principle of the disclosure and these improvements and embellishments shall also fall within the scope of protection of the disclosure.

1. A method for signal strength detection, comprising:
sending measurement configuration information and reporting configuration information for Received Signal Strength Indication (RSSI) measurement to a terminal; and
receiving a report value of the RSSI measurement reported by the terminal, wherein the measurement configuration information is used to instruct the terminal to perform the RSSI measurement to obtain RSSI sample values, and the reporting configuration information is used to instruct the terminal to process the RSSI sample values to obtain the report value of the RSSI measurement.

2. The method according to claim 1, wherein the measurement configuration information comprises at least one of measurement frequency, measurement configuration of a reference signal, an RSSI measurement starting event or period, or prompt information, wherein the prompt information is used to prompt whether to remove a Reference Signal Received Power (RSRP) of a serving cell from the RSSI sample values.

3. The method according to claim 1, wherein the reporting configuration information comprises: an RSSI reporting threshold value and an RSSI reporting event or period.

4. The method according to claim 1, wherein the reporting configuration information further comprises a reporting type of the RSSI sample values, wherein the reporting type of the RSSI sample values is at least one of a mean value of the RSSI sample values, a ratio of the RSSI sample values higher than the RSSI reporting threshold value to all the RSSI sample values, or a mean value of the RSSI sample values higher than the RSSI reporting threshold value.

5. A method for signal strength detection, comprising:
receiving measurement configuration information and reporting configuration information for Received Signal Strength Indication (RSSI) measurement issued from a network side;
performing the RSSI measurement to obtain RSSI sample values according to the measurement configuration information; and
processing the RSSI sample values to obtain a report value of RSSI measurement according to the reporting configuration information, and reporting the report value of RSSI measurement to the network side.

6. The method according to claim 5, wherein the measurement configuration information comprises at least one of measurement frequency, measurement configuration of a reference signal, an RSSI measurement starting event or period and prompt information, wherein the prompt information is used to prompt whether to remove a Reference Signal Received Power (RSRP) of a serving cell from the RSSI sample values.

7. The method according to claim 6, wherein performing the RSSI measurement to obtain the RSSI sample values according to the measurement configuration information comprises:
when the RSSI measurement starting event or period is met, performing the RSSI measurement to obtain the RSSI sample values;
when the RSSI sample values comprise a valid reference signal, removing the RSRP in the RSSI sample values, and regarding the processed RSSI sample values as first RSSI sample values; and
when the RSSI sample values do not comprise any valid reference signal, regarding the RSSI sample values as second RSSI sample values.

8. The method according to claim 7, wherein removing the RSRP in the RSSI sample values and regarding the processed RSSI sample values as the first RSSI sample values comprise:
subtracting the RSRP in the RSSI sample values according to RSSI_DRS=RSSI_drs-RSRP, wherein RSSI_DRS represents the first RSSI sample value, RSSI_drs represents the RSSI sample value, and RSRP represents the RSRP of the serving cell; or,
subtracting the RSRP in the RSSI sample values according to RSSI_DRS=RSSI_drs-N×RSRP, wherein RSSI_DRS represents the first RSSI sample value, RSSI_drs represents the RSSI sample value, N represents a number of Resource Blocks (RBs) in a measurement bandwidth, and RSRP represents the RSRP of the serving cell; or,
subtracting the RSRP in the RSSI sample values according to RSSI_DRS=RSSI_drs-N×M×RSRP, wherein RSSI_DRS represents the first RSSI sample value, RSSI_drs represents the RSSI sample value, N represents the number of RBs in the measurement bandwidth, M represents a number of Resource Elements (REs) for RSRP measurement in each RB, and RSRP represents the RSRP of the serving cell.

9. The method according to claim 7, wherein processing the RSSI sample values to obtain the report value of RSSI measurement according to the reporting configuration information and reporting the report value of RSSI measurement to the network side specifically comprises:
combining the first RSSI sample values and the second RSSI sample values into an RSSI sample set;
processing the first RSSI sample values and second RSSI sample values in the RSSI sample value set to obtain the report value of RSSI measurement according to a reporting type of the RSSI sample values, wherein the reporting configuration information comprises the reporting type of the RSSI sample values; and
reporting the report value of RSSI measurement to the network side.

10. The method according to claim 9, wherein the reporting type of the RSSI sample values is at least one of a mean value of the RSSI sample values, a ratio of the RSSI sample values higher than an RSSI reporting threshold value to all the RSSI sample values, or a mean value of the RSSI sample values higher than the RSSI reporting threshold value.

11. The method according to claim 5, wherein the reporting configuration information comprises the RSSI reporting threshold value and an RSSI reporting event or period.

12. A device for signal strength detection, comprising:
a sender, configured to send measurement configuration information and reporting configuration information for Received Signal Strength Indication (RSSI) measurement to a terminal; and
a receiver, configured to receive a report value of RSSI measurement reported by the terminal, wherein the measurement configuration information is used to instruct the terminal to perform the RSSI measurement to obtain RSSI sample values, and the reporting configuration information is used to instruct the terminal to process the RSSI sample values to obtain the report value of the RSSI measurement.

13. The device according to claim 12, wherein the measurement configuration information comprises at least one of measurement frequency, measurement configuration of a reference signal, an RSSI measurement starting event or period and prompt information, wherein the prompt information is used to prompt whether to remove a Reference Signal Received Power (RSRP) of a serving cell from the RSSI sample values.

14. The device according to claim 12, wherein the reporting configuration information comprises: an RSSI reporting threshold value and an RSSI reporting event or period.

15. The device according to claim 12, wherein the reporting configuration information further comprises a reporting type of the RSSI sample values, wherein the reporting type of the RSSI sample values is at least one of a mean value of the RSSI sample values, a ratio of the RSSI sample values higher than the RSSI reporting threshold value to all the RSSI sample values, or a mean value of the RSSI sample values higher than the RSSI reporting threshold value.

16. A device for signal strength detection, comprising:
a receiver, configured to receive measurement configuration information and reporting configuration information for Received Signal Strength Indication (RSSI) measurement issued from a network side;
a first processor, configured to perform the RSSI measurement to obtain RSSI sample values according to the measurement configuration information; and
a second processor, configured to process the RSSI sample values to obtain a report value of RSSI measurement according to the reporting configuration information, and report the report value of RSSI measurement to the network side.

17. The device according to claim 16, wherein the measurement configuration information comprises at least one of measurement frequency, measurement configuration of a reference signal, an RSSI measurement starting event or period and prompt information, wherein the prompt information is used to prompt whether to remove a Reference Signal Received Power (RSRP) of a serving cell from the RSSI sample values.

18. The device according to claim 17, wherein the first processor is further configured to, when the RSSI measurement starting event or period is met, perform the RSSI measurement to obtain the RSSI sample values; when the RSSI sample values comprise a valid reference signal, remove RSRP in the RSSI sample values, and regard the processed RSSI sample values as first RSSI sample values; and when the RSSI sample values do not comprise any valid reference signal, regard the RSSI sample values as second RSSI sample values.

19. The device according to claim 18, wherein the first processor is further configured to subtract the RSRP in the RSSI sample values according to RSSI_DRS=RSSI_drs-RSRP, wherein RSSI_DRS represents the first RSSI sample value, RSSI_drs represents the RSSI sample value, and RSRP represents the RSRP of the serving cell; or, subtract the RSRP in the RSSI sample values according to RSSI_DRS=RSSI_drs-N×RSRP, wherein RSSI_DRS represents the first RSSI sample value, RSSI_drs represents the RSSI sample value, N represents a number of Resource Blocks (RBs) in a measurement bandwidth, and RSRP represents the RSRP of the serving cell; or, subtract the RSRP in the RSSI sample values according to RSSI_DRS=RSSI_drs-N×M×RSRP, wherein RSSI_DRS represents the first RSSI sample value, RSSI_drs represents the RSSI sample value, N represents the number of RBs in the measurement bandwidth, M represents a number of Resource Elements (REs) configured for RSRP measurement in each RB, and RSRP represents the RSRP of the serving cell.

20. The device according to claim 18, wherein the second processor is further configured to combine the first RSSI sample values and the second RSSI sample values into an RSSI sample set; process the first RSSI sample values and second RSSI sample values in the RSSI sample value set to obtain the report value of RSSI measurement according to a reporting type of the RSSI sample values, wherein the reporting configuration information comprises the reporting type of the RSSI sample values; and report the report value of RSSI measurement to the network side.

21. The device according to claim 20, wherein the reporting type of the RSSI sample values is at least one of a mean value of the RSSI sample values, a ratio of the RSSI sample values higher than an RSSI reporting threshold value to all the RSSI sample values, or a mean value of the RSSI sample values higher than the RSSI reporting threshold value.

22. The device according to claim 16, wherein the reporting configuration information comprises the RSSI reporting threshold value and an RSSI reporting event or period.
